(19) United States
(12) Patent Application Publication
(10) Pub. No.: US 2004/0184173 A1
(43) Pub. Date: Sep. 23, 2004

(54) Near-infrared absorption film

(75) Inventors: Taichi Kobayashi, Kodaira-shi (JP); Masato Sugimachi, Kodaira-shi (JP); Masato Yoshikawa, Kodaira-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 10/817,002

(22) Filed: Apr. 5, 2004

Related U.S. Application Data
(63) Continuation of application No. PCT/JP02/10252, filed on Oct. 2, 2002.

(30) Foreign Application Priority Data
Apr. 10, 2001 (JP) 2001-308849

(51) Int. Cl. G02B 5/22

(52) U.S. Cl. 359/885; 252/587

(57) ABSTRACT

A near-infrared absorption film which is excellent in transmittance to visible light in wide wavelengths has a base film and a near-infrared absorption layer which contains a diimmonium compound. The diimmonium compound has an endothermic peak of 220° C. or more, determined from differential scanning calorimetry (DSC measurement) with temperature rising rate of 10° C./minute. The near-infrared absorption layer may further contain a cyanine compound, a phthalocyanine compound, a naphthalocyanine compound, or a nickel complex compound. The near-infrared absorption layer may still further contain a quencher compound.

### CROSS REFERENCE TO RELATED APPLICATION

This is a continuation application of PCT/JPO2/10252 filed on Oct. 2, 2002.

### FIELD OF THE INVENTION

The present invention relates to a near-infrared absorption film.

### BACKGROUND OF THE INVENTION

In an electromagnetic-wave shielding and light transmitting plate used as a front filter of a PDP (plasma display panel), a near-infrared absorption film may be attached to the electromagnetic-wave shielding and light transmitting plate at the PDP side. The near-infrared absorption film absorbs near-infrared absorption rays introducing errors of other peripheral electronics devices. As conventional near-infrared absorption films, there are a filter made of phosphate glass containing metallic ion such as copper or iron; an interference filter which is obtained by forming layers having different refractive indexes on a substrate and allows the transmission of specific wavelengths by interfering with transmitting lights; an acrylic resin filter containing copper ion; a filter obtained by dispersing a dye into polymer; and the like.

As for the near-infrared absorption film obtained by dispersing a dye into polymer, the near-infrared absorption property of filter becomes poor as the dye is deteriorated by heat, oxidation, or the like.

### DISCLOSURE OF THE INVENTION

A near-infrared absorption film of the present invention has a base film and a near-infrared absorption layer formed on the base film, and is characterized in that the near-infrared absorption layer contains a diimmonium compound which has an endothermic peak of 220° C. or more, determined from differential scanning calorimetry (DSC measurement) with temperature rising rate of 10° C./minute.

### DETAILED DESCRIPTION

A near-infrared absorption film has a base film and a near-infrared absorption layer formed on the base film and may further have another layer.

The near-infrared absorption layer contains a diimmonium compound and may further contain another component.

The diimmonium compound has endothermic peak of 220° C. or more, determined from differential scanning calorimetry (DSC measurement) with temperature rising rate of 10° C./minute. This diimmonium compound has high degree of purity so as to improve the durability of the near-infrared absorption film.

The diimmonium compound preferably has endothermic peak of 225° C. or more, more preferably from 225° C. to 240° C., determined from the differential scanning calorimetry (DSC measurement) with temperature rising rate of 10° C./minute.

The differential scanning calorimetry (DSC measurement) is a method of measuring, as a temperature function, differences in energy input between a measurement objective material and a reference material while the temperature was changed according to program by means of a heat flow DSC calorimeter. The temperature at endothermic peak indicate a temperature (melting point) at an intersection point of tangential lines drawn at the maximum inclinations on both sides of the endothermic peak.

The diimmonium compound is preferably a compound represented by the following formula (I) or (II):

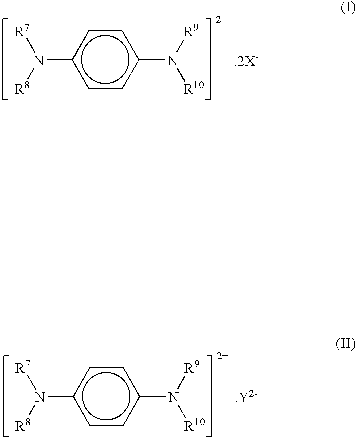

In the formulae (I) and (II), each of R⁷ through R¹⁰ is at least one of an alkyl group, an aryl group, a group having aromatic ring, a hydrogen atom, and a halogen atom, X⁻ is a monovalent anion, and Y²⁻ is a divalent anion.

The monovalent anion represented by X⁻ may be a halogen ion such as I⁻, Cl⁻, Br⁻, or F⁻; an inorganic acid ion such as NO₃⁻, BF₄⁻, PF₆⁻, ClO₄⁻, or SbF₆⁻; an organic carboxylic acid ion such as CH₃COO⁻, CF₃COO⁻, or benzoic acid ion; an organic sulfonic acid ion such as CH₃SO₃⁻, CF₃SO₃⁻, benzenesulfonic acid ion, or naphthalenesulfonic acid ion.

The divalent anion represented by Y²⁻ is preferably an aromatic disulfonic acid ion having two sulfonic acid groups. Specific examples are anion of naphthalenedisulfonic acid derivatives such as naphthalene-1,5-disulfonic acid, R acid, G acid, H acid, benzoyl H acid (a benzoyl group being attached to an amino group of H acid), p-chlorobenzoyl H acid, p-toluenesulfonyl H acid, chloro H acid (an amino group of H acid being replaced with a chlorine atom), chloroacetyl H acid, metanyl γ acid, 6-sulfonaphthyl-γ acid, C acid, ε acid, p-toluenesulfonyl R acid, naphthalene-1,6-disulfonic acid or 1-naphthol-4,8-disulfonic acid; carbonyl J acid, 4,4-diaminostilbene-2,2′-disulfonic acid, di-J acid, naphthalic acid, naphthalene-2,3-dicarboxylic acid, diphenic acid, stilbene-4,4′-dicarboxylic acid, 6-sulfo-2-oxy-3-naphthoic acid, anthraquinone-1,8-disulfonic acid, 1,6-diaminoanthraquinone-2,7-disulfonic acid, 2-(4-sulfophenyl)-6-aminobenzotriazole-5-sulfonic acid, 6-(3-methyl-5-pyrazolonyl)-naphthalene-1,3-disulfonic acid, 1-naphthol-6-(4-amino-3-sulfo)anilino-3-sulfonic acid, and the like. Among these, a naphthalenedisulfonic acid ion is preferable and a naphthalenedisulfonic acid ion represented by the following formula (III) is especially preferable:

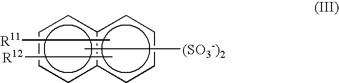

In the formula (III), each of R¹¹ and R¹² is at least one selected from a group consisting of a lower alkyl group, a hydroxyl group, an alkylamino group, an amino group, —NHCOR¹³, —NHSO₂R¹³, —OSO₂R¹³ (where R¹³ is at least one selected from a group consisting of aryl groups and alkyl groups, R¹³ may have substituent(s)), an acetyl group, a hydrogen atom, or a halogen atom.

A suitable example of the diimmonium compound is represented by the following formula (IV):

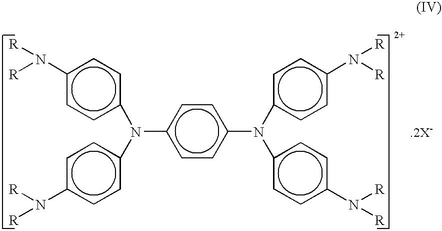

In the formula (IV), R is an alkyl group having 1 to 8 carbon atoms, preferably a n-butyl group, and X⁻ as the monovalent anion is preferably BF₄⁻, PF₆⁻, ClO₄⁻, or SbF₆⁻. A diimmonium compound in which R is a butyl group and X⁻ is SbF₆⁻ represented by the following formula (V)

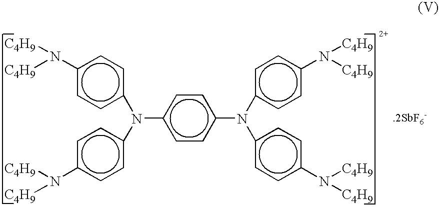

The near-infrared absorption layer may contain only one or two or more of the aforementioned diimmonium compounds. The near-infrared absorption layer preferably contains about 0.1% to 10% by weight of diimmonium compound.

The near-infrared absorption layer may contain another compound besides the diimmonium compound. Such compound may be a cyanine compound, a phthalocyanine compound, a naphthalocyanine compound, a nickel complex compound, and/or a quencher compound.

The cyanine compound may be a compound represented by the following formula (VI):

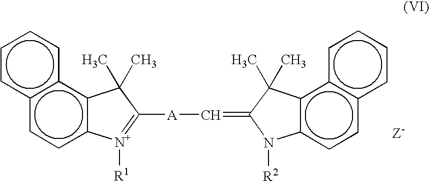

In the formula (VI), A is a divalent bonded group containing an ethylene group. Particularly preferable cyanine compound is:

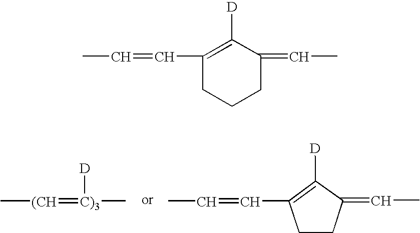

(D is one of an alkyl group, diphenyl amino group, a halogen atom, and hydrogen atom). That is, specific examples of the cyanine compound represented by the formula (VI) are represented by the following formulae (VII), (VIII), and (IX). The cyanine compound has a function of making the transmittance for visible light and the color of the near-infrared absorption layer better.

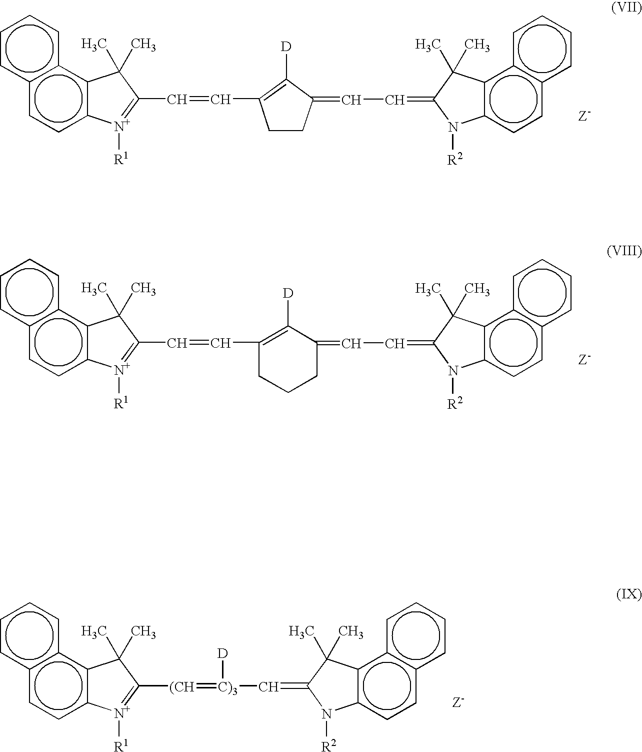

In the formulae (VI) through (IX), each of R¹ and R² is a monovalent group having a carbon atom and may be an alkyl group, an aryl group, an alkoxy group, an alkoxy carbonyl group, a sulfonyl alkyl group, or a cyano group. Z⁻ is a monovalent anion and may be I⁻, Br⁻, ClO₄⁻, or BF₄⁻, PF₆⁻, SbF₆⁻, CH₃SO₄⁻, NO₃, or CH₃—C₆H₄—SO₃—.

The near-infrared absorption layer may contain 50 parts by weight or less, preferably from 0.1 to 50 parts by weight, more preferably from 1 to 50 parts by weight of the cyanine compound relative to 100 parts by weight of the aforementioned diimmonium compound.

When the content is 0.1 parts by weight or more, the cyanine compound can exhibits its function of improving the blocking performance against near-infrared rays. On the other hand, when the content exceeds 50 parts by weight, the cyanine compound may make the transmittance of visible light poor.

The phthalocyanine compound which can be contained in the near-infrared absorption layer may be a compound represented by the following formula (X):

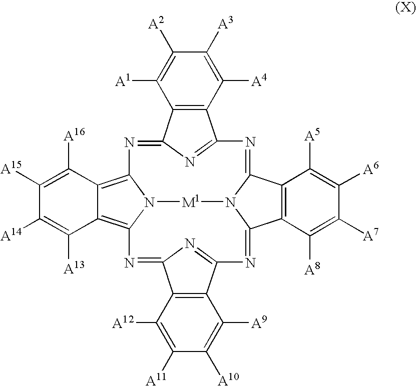

In the formula (X), A¹ through A¹⁶ each represent independently either one of the followings, i.e. a hydrogen atom, a halogen atom, a hydroxyl group, an amino group, a hydroxysulfonyl group, an aminosulfonyl group, or a substituent having from 1 to 20 carbon atoms. The substituent having from 1 to 20 carbon atoms may contain either one of the followings, i.e. a nitrogen atom, a sulfur atom, an oxygen atom, and a halogen atom. Adjacent two substituents may be bonded to each other via a conjugating group. Each of at least four of A¹ through A¹⁶ is at least either one of a substituent via sulfur atom and a substituent via nitrogen atom. M¹ is either one of the followings, i.e. two hydrogen atoms, a divalent metallic atom, a trivalent or quadrivalent substituted metallic atom, and an oxy metal.

The naphthalocyanine compound which can be contained in the near-infrared absorption layer may be a compound represented by the following formula (XI):

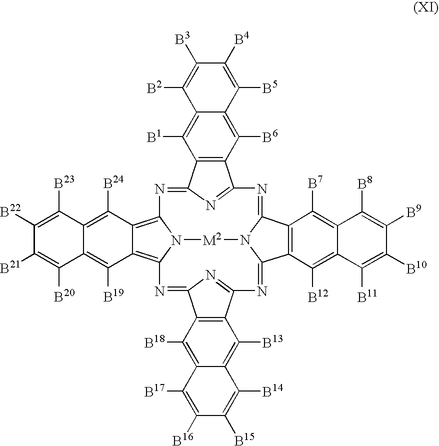

In the formula (XI), B¹ through B²⁴ each represent independently either one of the followings, i.e. a hydrogen atom, a halogen atom, a hydroxyl group, an amino group, a hydroxysulfonyl group, an aminosulfonyl group, or a substituent having from 1 to 20 carbon atoms. The substituent having from 1 to 20 carbon atoms may contain a nitrogen atom, a sulfur atom, an oxygen atom, and a halogen atom. Adjacent two substituents maybe bonded to each other via a conjugating group. Each of at least four of B¹ through B²⁴ is at least either one of a substituent via oxygen atom, a substituent via sulfur atom, a substituent via nitrogen atom. M² is either one of the followings, i.e. two hydrogen atoms, a divalent metallic atom, a trivalent or quadrivalent substituted metallic atom, and an oxy metal.

The quencher compound which can be contained in the near-infrared absorption layer may be a metallic compound represented by the following formula (XII) or (XIII), or an aminium compound represented by the following formula (XIV):

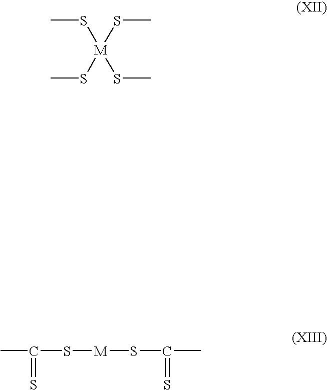

In the formulae (XII) and (XIII), M is Ni, Cu, Co, Pt, or Pd.

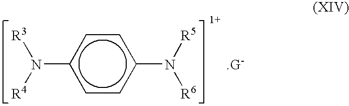

In the formula (XIV), each of R³ through R⁶ is at least one selected from a group consisting of an alkyl group, an aryl group, a group having aromatic ring, a hydrogen atom, and a halogen atom, and G⁻ is I⁻, Br⁻, ClO₄⁻, or BF₄⁻, PF₆⁻, SbF₆⁻, CH₃SO₄⁻, NO₃⁻, or CH₃—C₆H₄—SO₃⁻.

The metallic compound represented by the formula (XII) may be a 1,2-benzenethiol copper complex compound or a 1,2-benzenethiol nickel complex compound. Specific examples are compound represented by formulae (XV) and (XVI). These compounds can exhibit a function of preventing the oxidization of the near-infrared absorption layer so as to improve the durability of the near-infrared absorption layer. (t)Bu means a t-butyl group and (n)Bu means a n-butyl group.

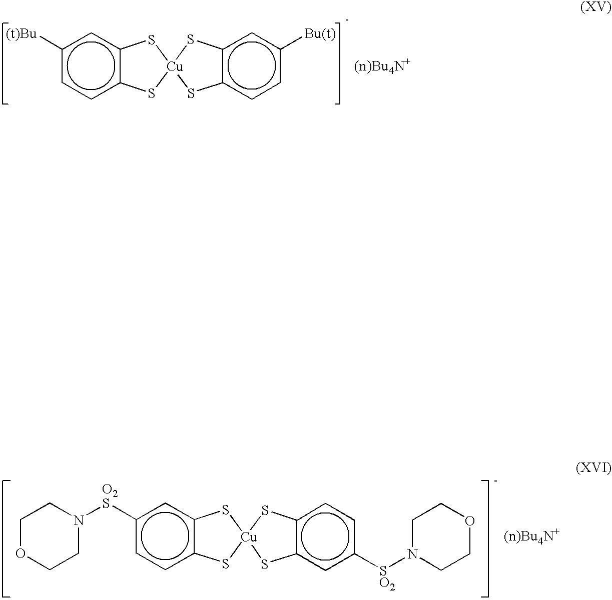

The metallic compound represented by the formula (XIII) may be a complex represented by the following formula (XVII). This complex can exhibit a function of preventing the oxidization of the near-infrared absorption layer so as to improve the durability of the near-infrared absorption layer.

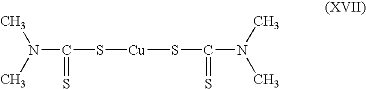

The near-infrared absorption layer may contain 100 parts by weight or less, preferably from 0.01 to 100 parts by weight, more preferably from 0.1 to 50 parts by weight of the quencher compound relative to 100 parts by weight of the diimmonium compound.

Though the quencher compound can exhibits its function of improving the durability such as heat resistance, oxidation resistance and moisture resistance, the quencher compound can color the near-infrared absorption layer so as to make the appearance of the near-infrared absorption layer poor.

The nickel complex compound which can be contained in the near-infrared absorption layer has a function of absorbing near-infrared rays.

The near-infrared absorption layer may further contain other components, for example, a binder resin, a near-infrared absorbent (e.g. near-infrared absorbents of azo series, polymethine series, diphenylmethane series, triphenylmethane series, and quinine series), an antioxidant other than the quencher compound (e.g. antioxidants of phenol series, amine series, hindered bisphenol series, hindered amine series, sulfur series, phosphoric acid series, phosphorous acid series, and metallic complex series), an UV absorbent, and a colorant, a pigment, and a dye for improving the appearance of the film.

The binder resin may be polyester resin, acrylic resin, methacrylic resin, urethane resin, silicone resin, phenol resin, or a homopolymer or copolymer of (meth) acrylic acid ester. Among these, acrylic resin or polyester resin may be preferably used from the viewpoints of dispersibility of the diimmonium compound and the durability.

The thickness of the near-infrared absorption layer may be from 0.5 μm to 50 μm. Though the thickness in this range is better for the near-infrared absorption and transmittance for visible light, the thickness is not limited thereto.

The base film is made of a synthetic resin and may be made of polyolefine resin such as polyethylene and polypropylene, polyester resin, acrylic resins, cellulose resin, polyvinylchloride resin, polycarbonate resin, phenol resin, or urethane resin. Among these, polyester resin is preferable because of high transparency and lower risk of environmental pollution. The transparency means the transparency relative to visible light.

The thickness of the base film may be from 50 μm to 200 μm. The thickness in this range can impart sufficient mechanical strength to the base film.

Coating liquid is prepared by dissolving the diimmonium compound, the binder resin, and the like into a solvent and is coated on the base film, thereby manufacturing the near-infrared absorption film. The solvent may be dichloromethane, methyl ethyl ketone, tetrahydrofuran, or cyclohexanone.

The near-infrared absorption film may have one near-infrared absorption layer or two or more near-infrared absorption layers on the base film.

The near-infrared absorption film as described in the above can sufficiently absorb near-infrared rays and transmit visible light of wavelengths in a wide range. Since the film has excellent durability, particularly excellent durability in high-temperature and high-humidity conditions, the film can be adopted to various applications.

### EXAMPLES

Hereinafter, examples of the present invention will be described. The present invention is not limited to the following examples.

### Examples 1-4, Comparative Examples 1-4

### Production of Near-infrared Absorption Film

Diimmonium compound (CIR1081; available from Japan Carlit Co., Ltd.) represented by the aforementioned formula (V) was refined. By raising the purity step by step during the refining process, refined diimmonium compounds of three kinds with different purities were obtained. As for each of the obtained diimmonium compounds, 1 mg was weighed in a cell made of aluminum and the temperature at heat absorption peak (melting point) was measured by a differential scanning calorimeter (DSC-3100; available from MAC Science Co., Ltd.) The results were 227° C., 220° C., and 210° C., respectively. The temperature rising rate during the measurement was 10° C./minute. The melting point of CIR1081diimmonium compound mentioned above was measured and the result was 207° C.

Each diimmonium compound and each binder resin indicated in Table 1 were dissolved in the respective amounts indicated in Table 1 into a mixed solvent consisting of 18.5 g of dichloromethane, 55.5 g of tetrahydrofuran, and 18.5 of methyl cellosolve acetate, thereby preparing each coating liquid. The coating liquid was coated on a polyester film (“T600E/WO7” having a thickness of 100 μm; available from Mitsubishi Polyester Film Corporation) by using a bar coater and was then dried at 100° C. for three minuets so as to form a near-infrared absorption film having a near-infrared absorption layer of 5 μm in thickness when dried.

### Durability Evaluation

The peak in absorbency of the obtained near-infrared absorption film was measured by a spectrophotometer (U-4000; available from Hitachi Instruments Service Co., Ltd.) and the result was used as initial absorbency I₀. Then, the absorbencies were measured after leaving the obtained near-infrared absorption film for 500 hours at 80° C. and 60% RH and for 500 hours at 60° C. and 90% RH, respectively. The results were each used as absorbency I₅₀₀. The residual ratio (%) of the diimmonium compound was calculated according to the following equation. The durability was evaluated such that the film in which the residual ratio of diimmonium compound was 92% or more was valued as “excellent” when, the film in which the residual ratio of diimmonium compound was 90% or more and less than 92% was valued as “good”, and the film in which the residual ratio of diimmonium compound was less than 90% was valued as “NG”. The results were shown in Table 2.

Residual ratio of diimmonium compound(%)=I₅₀₀/I₀

TABLE 1

| | Near-infrared Absorbent | | | Binder Resin | | |
|---|---|---|---|---|---|---|
| | | Melting Point | Amount | | Trade | Amount |
| | Compound | (° C.) | (g) | Compound | name | (g) |
| Example 1 | Diimmonium | 227 | 0.4 | Polyester resin | UE3690 | 7.5 |
| | compound | | | | | |
| Example 2 | Diimmonium | 220 | 0.4 | Polyester resin | UE3690 | 7.5 |
| | compound | | | | | |
| Example 3 | Diimmonium | 227 | 0.4 | PMMA | 80N | 7.5 |
| | compound | | | | | |
| Example 4 | Diimmonium | 220 | 0.4 | PMMA | 80N | 7.5 |
| | compound | | | | | |
| Comparative | Diimmonium | 210 | 0.4 | Polyester resin | UE3690 | 7.5 |
| Example 1 | compound | | | | | |
| Comparative | Diimmonium | 207 | 0.4 | Polyester resin | UE3690 | 7.5 |
| Example 2 | compound | | | | | |
| Comparative | Diimmonium | 210 | 0.4 | PMMA | 80N | 7.5 |
| Example 3 | compound | | | | | |
| Comparative | Diimmonium | 207 | 0.4 | PMMA | 80N | 7.5 |
| Example 4 | compound | | | | | |

Note:
“UE3690” is a polyester resin (Elytel UE3690; available from Unitika Ltd.)
“80N” is polymethyl methacrylate (PMMA resin) (Delpet 80N; available from Asahi Kasei Chemicals Corporation)

TABLE 2

| | | | | | Ex- | Comparative | Comparative | Comparative | Comparative |
|---|---|---|---|---|---|---|---|---|---|
| | | Example 1 | Example 2 | Example 3 | ample 4 | Example 1 | Example 2 | Example 3 | Example 4 |
| Residual | After 500 hours at | 94.7% | 93.9% | 92.7% | 90.5% | 85.4% | 84.2% | 86.1% | 81.4% |
| ratio of | 80° C. and 60% RH | | | | | | | | |
| diimmonium | After 500 hours at | 95.2% | 91.0% | 93.0% | 91.0% | 86.2% | 83.8% | 76.2% | 69.1% |
| compound | 60° C. and 90% RH | | | | | | | | |
| Evaluation | After 500 hours at | Excellent | Excellent | Excellent | Good | NG | NG | NG | NG |
| | 80° C. and 60% RH | | | | | | | | |
| | After 500 hours at | Excellent | Good | Excellent | Good | NG | NG | NG | NG |
| | 60° C. and 90% RH | | | | | | | | |

It is found from Table 2 that any one of Examples 1 through 4 has better durability as compared to Comparative Examples 1 through 4.

As described in the above, the present invention can provide a near-infrared absorption film which is excellent in blocking property against near-infrared rays, in transmittance to visible light within a wider range of wavelength, and also in durability.

What is claimed is:

1. A near-infrared absorption film having a base film and a near-infrared absorption layer formed on the base film, wherein
the near-infrared absorption layer contains a diimmonium compound which has an endothermic peak of 220° C. or more, determined from differential scanning calorimetry (DSC measurement) with temperature rising rate of 10° C./minute.

2. A near-infrared absorption film as claimed in claim 1, wherein the diimmonium compound has an endothermic peak from 225° C. to 240° C., determined from the differential scanning calorimetry (DSC measurement) with temperature rising rate of 10° C./minute.

3. A near-infrared absorption film as claimed in claim 1 or 2, wherein the diimmonium compound is at least one of compounds represented by the following formula (I) or (II): 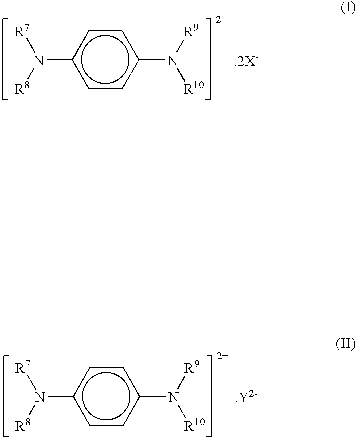
where each of R⁷ through R¹⁰ is at least one selected from a group consisting of an alkyl group, an aryl group, a group having aromatic ring, a hydrogen atom, and a halogen atom, X⁻ is a monovalent anion, and Y²⁻ is a divalent anion.

4. A near-infrared absorption film as claimed in claim 3, wherein the monovalent anion represented by X⁻ may be a halogen ion such as I⁻, Cl⁻, Br⁻, or F⁻; an inorganic acid ion such as NO₃⁻, BF₄⁻, PF₆⁻, ClO₄⁻, or SbF₆⁻; an organic carboxylic acid ion such as CH₃COO⁻, CF₃COO⁻, or benzoic acid ion; an organic sulfonic acid ion such as CH₃SO₃⁻, CF₃SO₃⁻, benzenesulfonic acid ion, or naphthalenesulfonic acid ion.

5. A near-infrared absorption film as claimed in claim 3, wherein the divalent anion represented by Y²⁻ is preferably an aromatic disulfonic acid ion having two sulfonic acid groups and specific examples of the divalent anion are an ion of naphthalenedisulfonic acid derivatives such as naphthalene-1,5-disulfonic acid, R acid, G acid, H acid, benzoyl H acid (a benzoyl group being attached to an amino group of H acid), p-chlorobenzoyl H acid, p-toluenesulfonyl H acid, chloro H acid (an amino group of H acid being replaced with a chlorine atom), chloroacetyl H acid, metanyl γ acid, 6-sulfonaphthyl-γ acid, C acid, ε acid, p-toluenesulfonyl R acid, naphthalene-1,6-disulfonic acid or 1-naphthol-4,8-disulfonic acid; carbonyl J acid, 4,4-diaminostilbene-2,2′-disulfonic acid, di-J acid, naphthalic acid, naphthalene-2,3-dicarboxylic acid, diphenic acid, stilbene-4,4′-dicarboxylic acid, 6-sulfo-2-oxy-3-naphthoic acid, anthraquinone-1,8-disulfonic acid, 1,6-diaminoanthraquinone-2,7-disulfonic acid, 2-(4-sulfophenyl)-6-aminobenzotriazole-5-sulfonic acid, 6-(3-methyl-5-pyrazolonyl)-naphthalene-1,3-disulfonic acid, 1-naphthol-6-(4-amino-3-sulfo)anilino-3-sulfonic acid.

6. A near-infrared absorption film as claimed in claim 5, wherein the divalent anion represented by Y²⁻ is an naphthalenedisulfonic acid ion.

7. A near-infrared absorption film as claimed in claim 6, wherein the naphthalenedisulfonic acid ion is represented by the following formula (III): 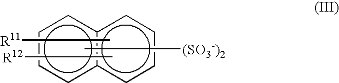
where each of R¹¹ and R¹² is at least one selected from a group consisting of a lower alkyl group, a hydroxyl group, an alkylamino group, an amino group, —NHCOR¹³, —NHSO₂R¹³, —OSO₂R¹³ (where R¹³ is at least one selected from a group consisting of aryl groups and alkyl groups, R¹³ may have substituent(s)), an acetyl group, a hydrogen atom, and a halogen atom.

8. A near-infrared absorption film as claimed in claim 1 or 2, wherein the diimmonium compound is represented by the following formula (IV): 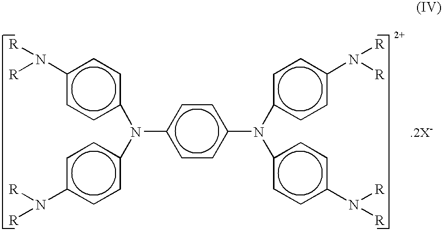
where R is an alkyl group having 1 to 8 carbon atoms, preferably a n-butyl group, and X⁻ as the monovalent anion is preferably BF₄⁻, PF₆⁻, ClO₄⁻, or SbF₆⁻.

9. A near-infrared absorption film as claimed in claim 8, wherein the diimmonium compound is represented by the following formula (V):

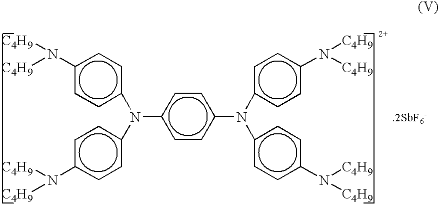

10. A near-infrared absorption film as claimed in any one of claims 1 through 9, wherein the near-infrared absorption layer contains 0.1% to 10% by weight of diimmonium compound.

11. A near-infrared absorption film as claimed in any one of claims 1 through 10, wherein the near-infrared absorption layer contains at least one selected from a group consisting of a cyanine compound, a phthalocyanine compound, a naphthalocyanine compound, and a nickel complex compound.

12. A near-infrared absorption film as claimed in claim 11, wherein the cyanine compound is a compound represented by the following formula (VI): 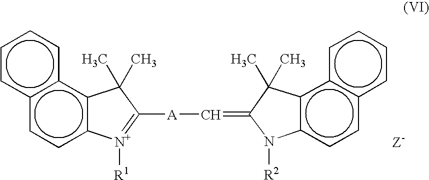
where A is a divalent conjugating group containing an ethylene group, each of R¹ and R² is a monovalent group having carbon atom(s), and Z⁻ is a monovalent anion.

13. A near-infrared absorption film as claimed in claim 12, wherein A is: 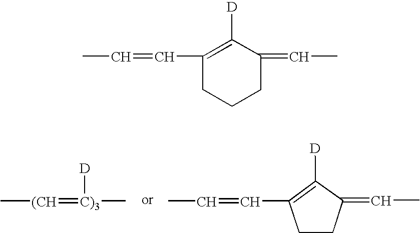
where D is one of an alkyl group, diphenyl amino group, a halogen atom, and hydrogen atom.

14. A near-infrared absorption film as claimed in claim 12 or 13, wherein each of R¹ and R² is an alkyl group, an aryl group, an alkoxy group, an alkoxy carbonyl group, a sulfonyl alkyl group, or a cyano group.

15. A near-infrared absorption film as claimed in claim 12 or 13, wherein Z⁻ is I⁻, Br⁻, ClO₄⁻, or BF₄⁻, PF₆⁻, SbF₆⁻, CH₃SO₄⁻, NO₃⁻, or CH₃—C₆H₄—SO₃⁻.

16. A near-infrared absorption film as claimed in any one of claims 12 through 15, wherein the near-infrared absorption layer contains 50 parts by weight or less of the cyanine compound relative to 100 parts by weight of said diimmonium compound.

17. A near-infrared absorption film as claimed in any one of claims 12 through 15, wherein the near-infrared absorption layer contains from 0.1 to 50 parts by weight of the cyanine compound relative to 100 parts by weight of said diimmonium compound.

18. A near-infrared absorption film as claimed in claim 11, wherein the phthalocyanine compound is represented by the following formula (X): 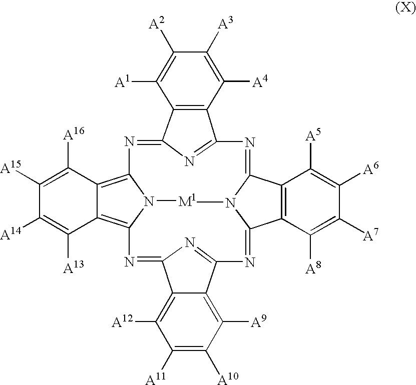
where A¹ through A¹⁶ each represent independently either one of the followings, i.e. a hydrogen atom, a halogen atom, a hydroxyl group, an amino group, a hydroxysulfonyl group, an aminosulfonyl group, or a substituent having from 1 to 20 carbon atoms, the substituent having from 1 to 20 carbon atoms may contain either one of the followings, i.e. a nitrogen atom, a sulfur atom, an oxygen atom, and a halogen atom, and adjacent two substituents may be bonded to each other via a conjugating group, wherein each of at least four of A¹ through A¹⁶ is at least either one of a substituent via sulfur atom and a substituent via nitrogen atom, and M¹ is either one of the followings, i.e. two hydrogen atoms, a divalent metallic atom, a trivalent or quadrivalent substituted metallic atom, and an oxy metal.

19. A near-infrared absorption film as claimed in claim 11, wherein the naphthalocyanine compound is represented by the following formula (XI): 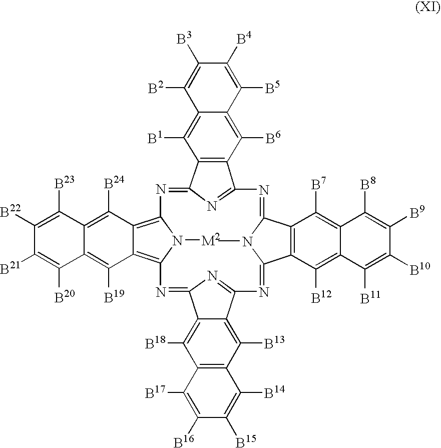
where B¹ through B²⁴ each represent independently either one of the followings, i.e. a hydrogen atom, a halogen atom, a hydroxyl group, an amino group, a hydroxysulfonyl group, an aminosulfonyl group, or a substituent having from 1 to 20 carbon atoms, the substituent having from 1 to 20 carbon atoms may contain a nitrogen atom, a sulfur atom, an oxygen atom, and a halogen atom, adjacent two substituents may be bonded to each other via a conjugating group, wherein each of at least four of B¹ through B²⁴ is at least either one of a substituent via oxygen atom, a substituent via sulfur atom, a substituent via nitrogen atom, and M² is either one of the followings, i.e. two hydrogen atoms, a divalent metallic atom, a trivalent or quadrivalent substituted metallic atom, and an oxy metal.

20. A near-infrared absorption as claimed in any one of claims 1 through 19, wherein the near-infrared absorption layer contains a quencher compound.

21. A near-infrared absorption as claimed in claim 20, wherein the quencher compound is a metallic compound represented by the following formula (XII) or (XIII), or an aminium compound represented by the following formula (XIV): 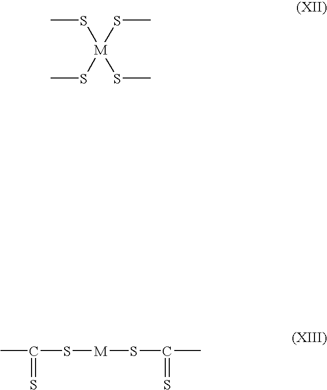
in the formulae (XII) and (XIII), M is Ni, Cu, Co, Pt, or Pd; 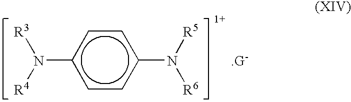
in the formula (XIV), each of R³through R⁶ is at least one selected from a group consisting of an alkyl group, an aryl group, a group having aromatic ring, a hydrogen atom, and a halogen atom. G⁻ is I⁻, Br⁻, ClO₄⁻, or BF₄⁻, PF₆⁻, SbF₆⁻, CH₃SO₄⁻, NO₃⁻, or CH₃—C₆H₄—SO₃⁻.

22. A near-infrared absorption film as claimed in claim 21, wherein the metallic compound represented by the formula (XII) is a 1,2-benzenethiol copper complex compound or a 1,2-benzenethiol nickel complex compound.

23. A near-infrared absorption film as claimed in claim 22, wherein 1,2-benzenethiol copper complex compound is represented by formula (XV) or (XVI):

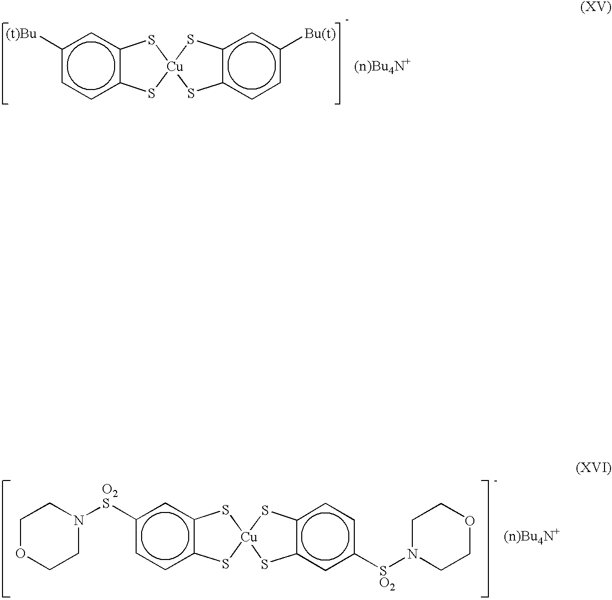

24. A near-infrared absorption film as claimed in claim 21, wherein the metallic compound represented by the formula (XIII) is a complex represented by the following formula (XVII):

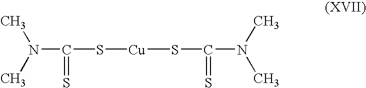

25. A near-infrared absorption film as claimed in any one of claims 20 through 24, wherein the near-infrared absorption layer contains 100 parts by weight or less of the quencher compound relative to 100 parts by weight of the diimmonium compound.

26. A near-infrared absorption film as claimed in any one of claims 1 through 25, wherein the near-infrared absorption layer contains a binder resin.

27. A near-infrared absorption film as claimed in claim 25, wherein the binder resin is polyester resin, acrylic resin, methacrylic resin, urethane resin, silicone resin, phenol resin, or a homopolymer or copolymer of (meth) acrylic acid ester.

28. A near-infrared absorption film as claimed in any one of claims 1 through 27, wherein the near-infrared absorption layer further contains a near-infrared absorbent (e.g. near-infrared absorbents of azo series, polymethine series, diphenylmethane series, triphenylmethane series, and quinine series), an antioxidant other than the quencher compound (e.g. antioxidants of phenol series, amine series, hindered bisphenol series, hindered amine series, sulfur series, phosphoric acid series, phosphorous acid series, and metallic complex series), an UV absorbent, and a colorant, a pigment, and a dye for improving the appearance of the film.

29. A near-infrared absorption film as claimed in any one of claims 1 through 28, wherein the thickness of the near-infrared absorption layer is from 0.5 μm to 50 μm.

30. A near-infrared absorption film as claimed in any one of claims 1 through 29, wherein the base film is made of a synthetic resin.

31. A near-infrared absorption film as claimed in any one of claim 30, wherein the synthetic resin is polyolefine resin such as polyethylene and polypropylene, polyester resin, acrylic resins, cellulose resin, polyvinylchloride resin, polycarbonate resin, phenol resin, or urethane resin.

32. A near-infrared absorption film as claimed in any one of claims 1 through 31, wherein the base film has a thickness from 50 μm to 200 μm.
